(19) United States
(12) Patent Application Publication
(10) Pub. No.: US 2006/0012570 A1
(43) Pub. Date: Jan. 19, 2006

(54) Protective cover of sensor surface that enables pointing operation

(75) Inventors: Manabu Yumoto, Nara-Shi (JP); Nobuhisa Tsuji, Osaka (JP); Sohichi Miyata, Nara-Shi (JP); Jun Ueda, Ikoma-Shi (JP); Tsukasa Ogasawara, Ikoma-Shi (JP)

Correspondence Address: BIRCH STEWART KOLASCH & BIRCH, PO BOX 747, FALLS CHURCH, VA, 22040-0747, US

(73) Assignees: Sharp Kabushiki Kaisha, Osaka (JP); National University Corporation Nara Institute of Science and Technology, Ikoma-Shi (JP)

(21) Appl. No.: 11/147,348

(22) Filed: Jun. 8, 2005

(30) Foreign Application Priority Data
Jun. 9, 2004 (JP) 2004-171553
Sep. 10, 2004 (JP) 2004-264331

(51) Int. Cl. G09G 5/08

(52) U.S. Cl. 345/157

(57) ABSTRACT

A pointing device that does not limit an operator by personal physical characteristics is structured as follows. An apparatus incorporating a pointing device includes a fingerprint sensor obtaining image information, a cover protecting a sensor surface, and a sensor presser arranged at a face of the cover on the sensor side so as to be in contact with the sensor surface. The shape of sensor presser obtained with sensor changes by the position on cover being pressed by a finger, and an input is performed based thereon.

This nonprovisional application is based on Japanese Patent Applications Nos. 2004-171553 and 2004-264331 filed with the Japan Patent Office on Jun. 9, 2004 and Sep. 10, 2004, respectively, the entire contents of which are hereby incorporated by reference.

### BACKGROUND OF THE INVENTION

1. Field of the Invention

The present invention relates to a sensor protective cover and to a pointing device, and particularly, to a sensor protective cover used when providing a computer with an instruction using a fingerprint sensor and to a pointing device that is small in size and that is capable of performing successive inputs.

2. Description of the Background Art

Japanese Patent Laying Open-No. 2002-062983 discloses implementation of a track pad apparatus and a fingerprint authentication apparatus in one apparatus, in which movement of a finger on the fingerprint authentication apparatus is detected as an input to a computer.

In the technique disclosed in the aforementioned Japanese Patent Laying Open-No. 2002-062983, the computer is operated based on the movement and deformation of a fingerprint pattern obtained with a fingerprint sensor.

However, the density and sharpness of an image obtained with a capacitance type fingerprint sensor tends to be largely affected by the difference in the environment such as humidity and temperature, and difference among individuals such as degree of perspiration. Accordingly, it has been difficult to realize a correct pointing operation.

Use of deformation of an operator's finger with the apparatus disclosed in Japanese Patent Laying Open-No. 2002-062983 is in part dependent on personal physical characteristics such as stiffness of the skin. Therefore, the target users allowed to use the apparatus have disadvantageously been limited.

With a track pad apparatus widely employed in a laptop computer or with the apparatus disclosed in Japanese Patent Laying Open-No. 2002-062983, a fingerprint sensor having an install area that would cover the range of finger movement (a sensor of a relatively large size) has been required for detecting the position of an operator's finger.

With an apparatus employing a conventional fingerprint sensor as a pointing device, the finger sensor must be touched by a finger directly, and therefore the surface of the sensor must constantly be exposed. Accordingly, when the sensor is incorporated into a portable computer or a mobile phone, there has been a possible damage to the sensor.

As an operator cannot wear gloves during the operation, there has been a trouble in use in a cold region.

Further, as the sensor surface is exposed, free designing of the entire apparatus has disadvantageously been limited.

### SUMMARY OF THE INVENTION

The present invention is made to solve the problems set forth above, and a first object is to provide a pointing device that does not limit an operator by personal physical characteristics.

A second object of the present invention is to provide a pointing device that has a small installation area and that is capable of reducing the size of the apparatus.

A third object of the present invention is to provide a sensor protective cover that can avoid a damage to the sensor, and a pointing device.

A fourth object of the present invention is to provide a pointing device enabling free designing of the apparatus and with high operability, while avoiding a damage to the sensor.

In order to achieve the objects above, according to one aspect of the present invention, a sensor protective cover includes a cover protecting a surface of a sensor, and a protrusion provided at a face in contact with the surface of the sensor, for causing the sensor to recognize pointing.

According to another aspect of the present invention, a pointing device includes a sensor obtaining image information, a cover protecting a surface of the sensor, a sensor presser arranged at a face of the cover on the sensor side so as to be in contact with the surface of the sensor, an image processor detecting a change in pressure applied on the cover based on an image obtained by the sensor, a movement detector detecting movement of an operator's finger based on the detected change in the pressure, and a converter converting the detected movement of the operator's finger into an input value to a computer.

According to the present invention, as the sensor surface can be operated by the protrusion or the presser, the pointing device that does not limit an operator by personal physical characteristics can be provided. Additionally, the pointing device that is small in the installation area and that is capable of reducing the size of the apparatus can be provided.

According to the present invention, further, the sensor protective cover that can avoid a damage to the sensor and the pointing device can be provided. Additionally, the pointing device enabling free designing of the apparatus and with high operability, while avoiding a damage to the sensor, can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1-3 show an external structure of an apparatus incorporating a pointing device according to an embodiment of the present invention.

FIG. 4 shows a structure of a sensor.

FIG. 5 is a block diagram showing a configuration of a pointing device incorporating apparatus 12.

FIG. 6 shows sensor output images of a pointing device using a cover and a sensor presser.

FIGS. 7 and 8 show a pointing device having four sensor pressers to a cover.

FIG. 9 shows a process of calculating a movement value of a pointer from an obtained image and the number of responding pixels by the obtained image for a pointing device having four sensor pressers to a cover.

FIG. 10 is a flowchart showing a process of calculating a movement value of a pointer from the number of responding pixels by an obtained image.

FIG. 11 shows a display screen when a moving process of a pointer by obtaining an image is successively performed.

FIG. 12 shows a state where a sensor is arranged so that the sensor face is presented to an operator in a diamond shape.

FIG. 13 shows a pointing device in which a cover, a pressing direction adjustment assisting member, and sensor pressers are used.

FIG. 14 shows a sensor output image of a pointing device in which a cover and sensor pressers are used.

FIG. 15 shows a sensor output image of a pointing device in which a cover, a pressing direction adjustment assisting member, and sensor pressers are used.

FIG. 16 shows a modification of the pointing device shown in FIG. 14.

### DESCRIPTION OF THE PREFERRED EMBODIMENTS

In the following, referring to the drawings, an embodiment of the present invention is described.

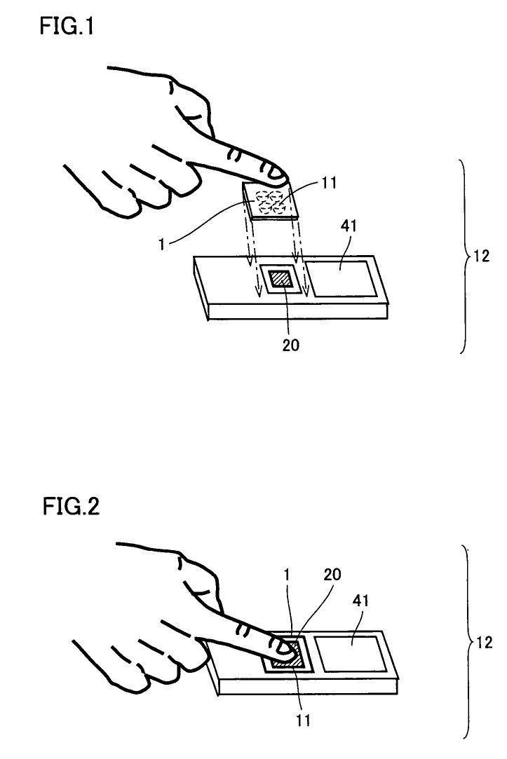

Referring to FIGS. 1-3, an apparatus 12 incorporating a pointing device is constituted by a fingerprint sensor 20 obtaining image information, a cover 1 protecting a sensor surface, a sensor presser 11 arranged at a face of the cover on the sensor side so as to be in contact with the sensor surface, a display screen 41 displaying information including pointer information, an image processor that is not shown, and a pointing device incorporating the sensor, the cover, the sensor presser, the display screen, and the image processor. Fingerprint sensor 20 is a fingerprint sensor employing a scheme of capacitance type, optical type, pressure-sensitive type or the like. Cover 1 is for protecting the sensor surface and for arranging the sensor presser. Sensor presser 11 is arranged at the face of the cover on the sensor side so as to be in contact with the sensor surface. Although resin and/or conductive resin are desirable as a material of sensor presser 11, the material is not necessarily limited thereto.

The image processor has an image processing algorithm detecting a change in pressure applied on the surface of cover 1 from an image, and a movement detection algorithm detecting a movement of an operator's finger from a change in an image by the detected pressure change, and an algorithm converting the detected movement of the operator's finger to an input value to a computer.

FIG. 1 shows a state where cover 1 and sensor presser 11 arranged at cover 1 are removed from pointing device incorporating apparatus 12. FIG. 2 shows a state where cover 1 and sensor presser 11 arranged at cover 1 are attached to pointing device incorporating apparatus 12.

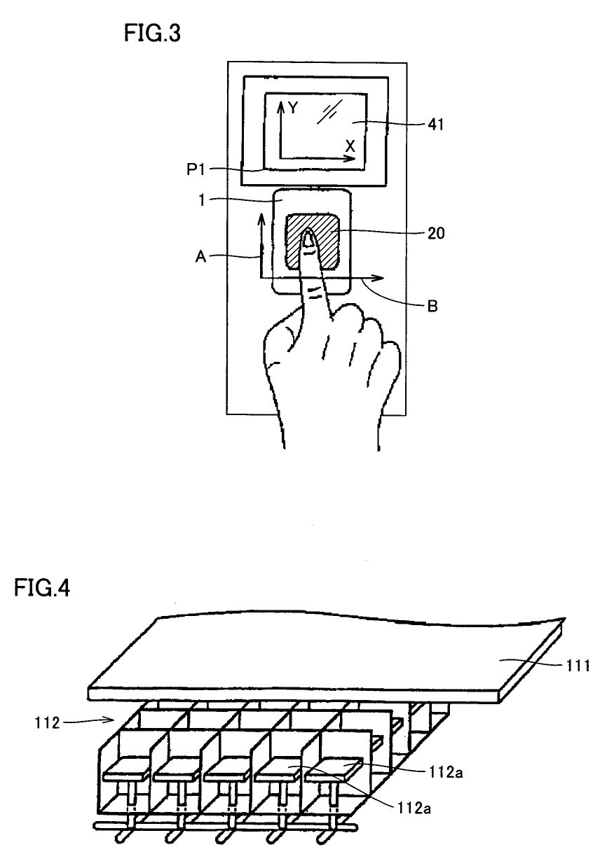

FIG. 3 is a plan view, seen from above, showing the state where cover 1 and sensor presser 11 arranged at cover 1 are attached to pointing device incorporating apparatus 12.

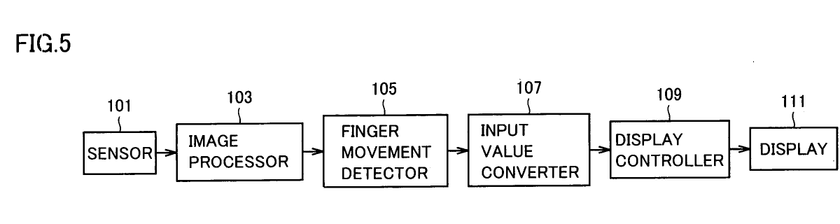

FIG. 4 shows a specific structure of sensor 20.

Although the structure of a capacitance type sensor is shown as a sensor in the present embodiment, the sensor is not limited thereto and an optical or pressure-sensitive type may be employed.

As shown in FIG. 4, sensor 20 of capacitance type includes a protective film 111 and an electrode group 112 in which electrodes 112a are arranged in prescribed rows and prescribed columns.

Each electrode 112a has characteristics that a charge quantity thereof varies depending on concavity and convexity of, for example, a finger placed on protective film 111 (that is, depending on a distance between protective film 111 and a finger, for example). Accordingly, a charge quantity of electrode 112a on which a trough (concave) portion of a fingerprint or the like is placed is smaller than that of an electrode on which a ridge (convex) portion of a fingerprint or the like is placed.

Then, converting charges on each electrode 112a into a voltage value, for example, corresponding to the charge quantity and then converting the voltage value into a digital value, an image of the fingerprint or the like can be obtained.

In the following description, an image or a fingerprint image refers to an image of an oblong quadrangle including a region where a user's fingerprint or the like is shown. The longitudinal direction of an image or a fingerprint image refers to a direction of a fingerprint image corresponding to arrow A in sensor 20 shown in FIG. 3, while the lateral direction refers to a direction corresponding to arrow B. The up direction is the direction indicated by arrow A, and the down direction is the direction opposite to the direction indicated by arrow A. The horizontal direction of display screen 41 is defined as X direction, and the direction perpendicular to X direction is defined as Y direction. The lower left vertex P1 of display screen 41 is defined as an origin point. Coordinate axis of X direction is defined as X coordinate, and coordinate axis of Y direction is defined as Y coordinate.

FIG. 5 is a block diagram showing the configuration of pointing device incorporating apparatus 12.

Referring to the drawing, pointing device incorporating apparatus 12 includes a sensor 101 (corresponding to sensor 20 in FIGS. 1-4), an image processor 103 processing an image obtained by sensor 101, a finger movement detector 105 detecting a movement of a user's finger based on the image, an input value converter 107 converting the detected finger movement into an input value of a computer, a display controller 109 controlling display of a display screen (such as a position of a pointer) based on the input, and a display 111 displaying the display screen.

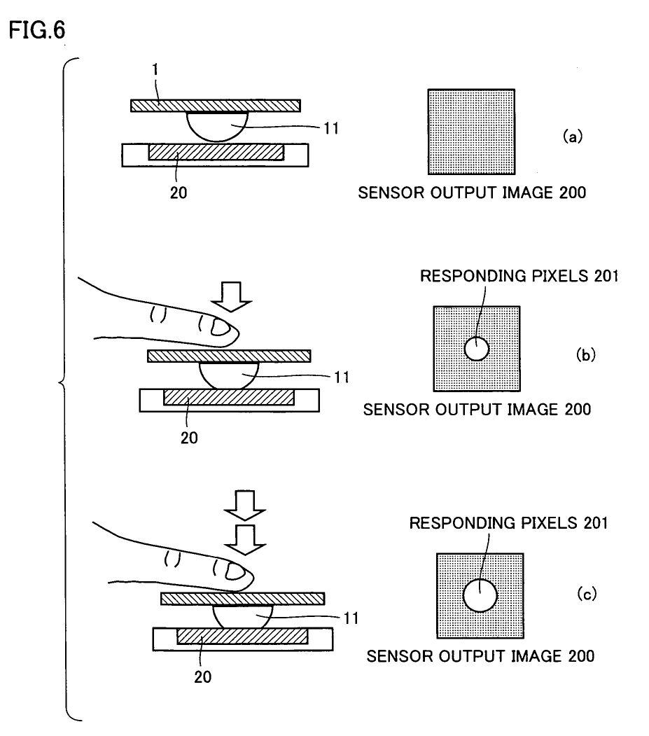

FIG. 6 shows a sensor output image of a pointing device in which the cover and the sensor presser are used.

FIG. 6 (a) shows a state where sensor presser 11 is about to contact fingerprint sensor 20. FIG. 6 (b) shows a state where sensor presser 11 is starting to contact fingerprint sensor 20. FIG. 6 (c) shows a state where sensor presser 11 is in contact with fingerprint sensor 20.

In each of FIGS. 6 (a) (b) (c), output image 200 of the fingerprint sensor resulted by sensor presser 11 being in contact with fingerprint sensor 20 is shown. As shown in the drawings, the output image changes depending on the degree of contact.

It is noted that, the pixels that reacted as the cover is pressed and the finger sensor is pressed by the sensor presser is referred to as “responding pixels” (denoted by reference character 201 in the drawings).

As shown in the drawing, since the position and material of sensor presser 11 for detecting the movement of a finger are fixed, conventional problems such as susceptibility of the density and sharpness of an image obtained by the sensor to differences in the environment such as humidity or temperature, differences and characteristics among individuals such as degree of perspiration and stiffness of the skin, do not occur.

When the sensor presser contacting the sensor surface is in a shape of a hemisphere or in a shape of a portion cut out from a sphere, greater applied pressure results in a larger portion of the sensor presser being in contact with the sensor surface, whereby the sensor pixel value around the portion changes. The sensor obtains this operation as continuous image information. With this structure, a change in the contact area of sensor surface and sensor presser tends to occur easily by a change in the applied pressure.

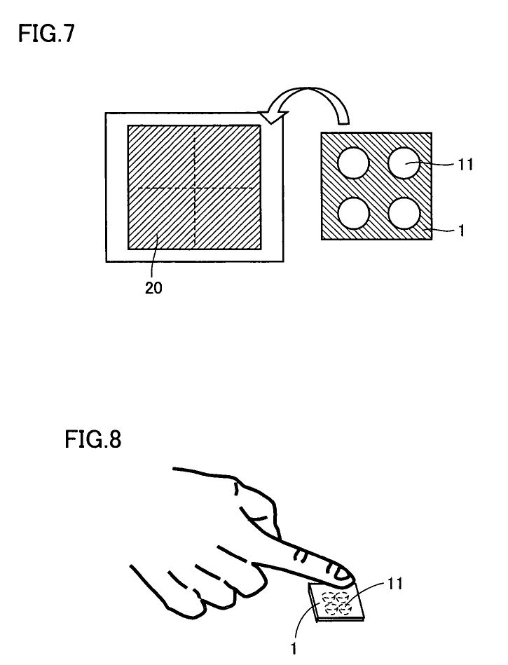

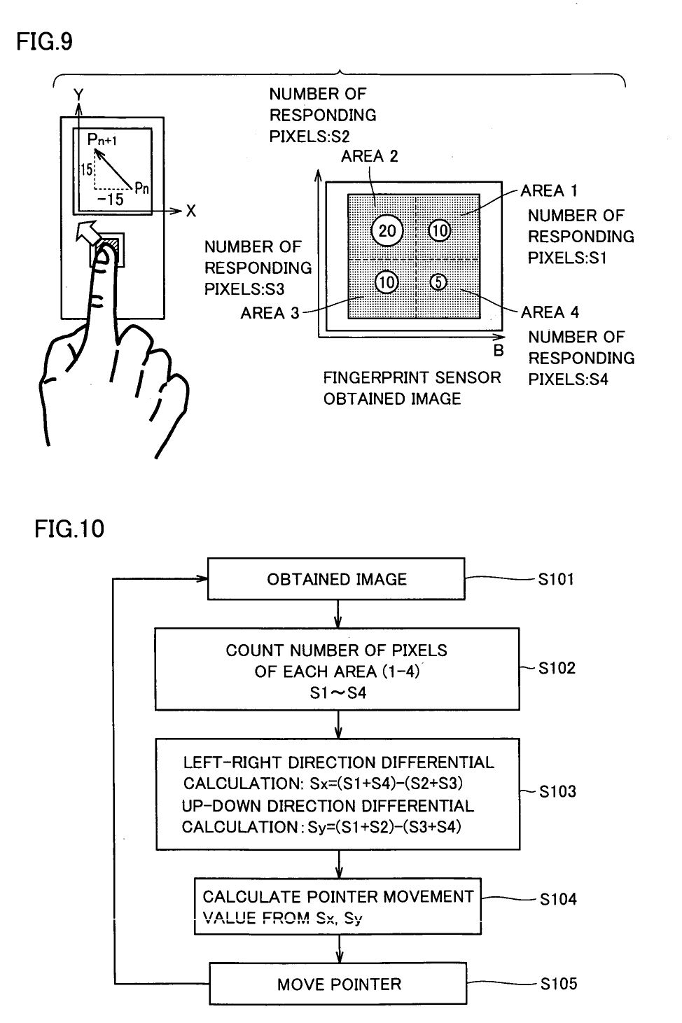

FIGS. 7 and 8 show a pointing device having four sensor pressers to a cover, while FIG. 9 shows an example of the obtained image, and a process of calculating a movement value of a pointer from the number of responding pixels by the obtained image, with reference to the pointing device having four sensor pressers to the cover shown in FIGS. 7 and 8. FIG. 10 is a flowchart showing a process of calculating the movement value of the pointer from the number of responding pixels by the obtained image.

Referring to FIGS. 7-10, a process of calculating a movement value of a pointer from an obtained image is described, with reference to a pointing device having four sensor pressers to a cover.

At step S101 in FIG. 10, an image is obtained. The image here changes in accordance with the degree of the sensor pressers being in contact with the fingerprint sensor, as described referring to FIG. 6.

In the example shown on the right side of FIG. 9, the number of responding pixels S2 of the sensor presser positioned in area 2 set in advance is “20” that is the greatest; the number of responding pixels S4 of the sensor presser positioned in area 4 is “5” that is the smallest; and the numbers of responding pixels S1, S3 of the sensor pressers positioned in areas 1 and 3 is “10” that is an intermediate value of the two.

At step S102 in FIG. 10, the number of responding pixels in each area is thus counted.

At step S103, each of the number of responding pixels is calculated, and differential calculation as to left-right and up-down directions is performed.

In this example, the left-right direction differential calculation is as follows.
Sx=(S1+S4)−(S2+S3)=(10+5)−(20+10)=−15

Whereas the up-down differential calculation is as follows.
Sy=(S1+S2)−(S3+S4)=(10+20)−(10+5)=15

Specifically, the pointer movement value is −15 in x direction and 15 in y direction (step S104).

Accordingly, as shown in FIG. 9, when the position of the pointer before obtaining this image is at Pn=(Pnx, Pny), the pointer is to move to the position of Pn+1=(Pnx−15, Pny+15) (step S105).

In the above description, while the sensor surface is divided into four portions, and four sensor pressers are arranged on the back surface of the cover so that each sensor presser is in contact with one of the portions, the present invention is not limited to this structure. The structure in which a plurality of (two, three, five . . . ) sensor pressers are provided may be employed.

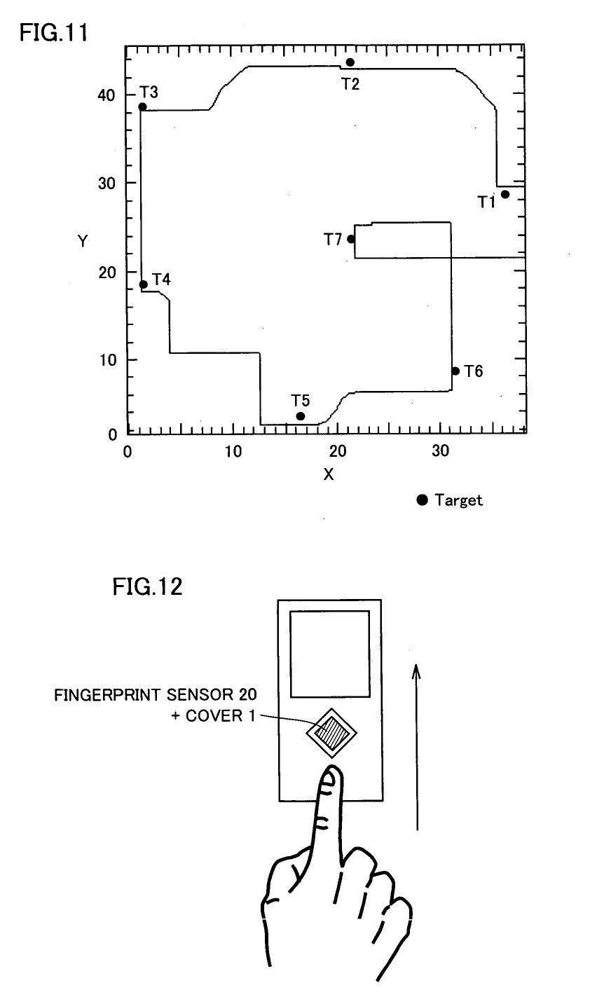

FIG. 11 shows a display screen when the aforementioned movement of the pointer (step S105) by obtaining an image (step S101) is performed successively.

In FIG. 11, T1-T7 shows location of targets where a pointer or a finger is to pass when moving, and a solid line drawn by a single stroke shows an actual track of a pointer.

It is noted that, since this structure allows pressing of a finger, with the arrangement intervals of the sensor pressers transmitting the applied pressure of the finger being narrower than the width of the operator's finger, a fingerprint sensor being smaller than the width of the operator's finger can be employed to reduce the size of the apparatus.

In the foregoing, while it has been described about the case where a sensor face is generally arranged to be a square to an operator when the sensor face to the operator is a quadrangle such as a square or an oblong quadrangle, the sensor may be inclined about 45° to be a diamond shape relative to the operator as shown in FIG. 12, when the sensor face to the operator is a quadrangle such as a square or an oblong quadrangle. Thus, the pressure applications near four vertexes of the rectangle respectively correspond to detection of the movement of operator's finger in up-down and left-right directions on an operation screen.

In this case, the sensor can be arranged in limited directions of up-down or left-right directions that are often employed in input of mobile phone or the like, and therefore the sensor face can effectively be utilized.

It should be noted that, as to a pointing device and a personal authentication function incorporating device, the cover may be removed when authentication of a user of the incorporating device is performed, and the cover may be attached when the pointing function is used. Additionally, the fingerprint sensor or the incorporating device and the cover may partially be connected to each other so that the cover would not fully fall off, when the cover protecting the sensor surface is removed for performing authentication. For example, the apparatus can be structured so that image processor 103 in FIG. 5 performs authentication based on an image of a fingerprint or the like obtained by the sensor.

### Effect Of The Embodiment

In the present embodiment, when a pressure is applied on the cover with a finger in a direction toward which the pointer of the apparatus incorporating the pointing device, such as a mobile phone, is desired to move, the pressure causes the contact area of the sensor pressers and the sensor surface to change. This change in the contact area corresponds to the change in image information obtained by the fingerprint sensor, and therefore the movement of the operator's finger can be detected through image processing and converted into an input value to a computer.

Since the position and material of the sensor pressers for detecting the movement of a finger are constantly fixed, conventional problems such as susceptibility of the density and sharpness of an image obtained by a capacitance type fingerprint sensor to differences in he environment such as humidity or temperature, the differences and physical characteristics among individuals such as degree of perspiration and stiffness of the skin can be solved.

The arrangement intervals of the sensor pressers transmitting the applied pressure of the finger can be set narrower than the width of the operator's finger, and consequently, a fingerprint sensor that is smaller than the width of the operator's finger can be employed to reduce the size of the apparatus.

As the fingerprint sensor is normally protected by the cover, damages from drop or shock can be avoided.

The cover may be decorated or painted to achieve free designing of the entire apparatus.

When each sensor presser contacting the fingerprint sensor surface is in a shape of a hemisphere or in a shape of a portion cut out from a sphere, a larger portion of the sensor presser is in contact with the sensor surface by the applied pressure, whereby the sensor pixel value around the portion changes. The sensor obtains the operation as successive image information. With this structure, advantageously, a change in the contact area of the fingerprint sensor surface and the sensor presser tends to occur easily by a change in the pressure applied by a finger.

When the sensor surface of an oblong quadrangle is divided into four portions, and aforementioned four sensor pressers are arranged on the back surface of the cover so that each conductive resin is in contact with one of the portions, the movements in up, down, left and right directions on a screen, which is normally employed in input to an apparatus incorporating the pointing device, can be detected with the minimum required sensor pressers that detect from a change in the contact area of the conductive resins and the fingerprint sensor face.

If the sensor is inclined about 45° to be a diamond shape to the operator when the sensor face relative to the operator is a quadrangle such as a square or an oblong quadrangle, in order to achieve an arrangement where the pressure applications near four vertexes of the quadrangle respectively correspond to detection of movement of the operator's finger in up-down and left-right directions on an operation screen, the sensor can be arranged longer in the directions limited in the up-down or left-right directions that is often employed in input to a mobile phone or the like. Thus, the sensor face can effectively be utilized.

With the structure where the cover is removed for performing authentication of a user of the incorporating apparatus and the cover is attached for using the pointing function, an effect of preventing loss of the cover is achieved, as the cover is constantly connected to the body while switching the personal authentication and the pointing function by removal and attachment of the cover.

When the image information reading scheme of the sensor is the capacitance type, desirably the material of sensor pressers is conductive resin.

### Another Embodiment

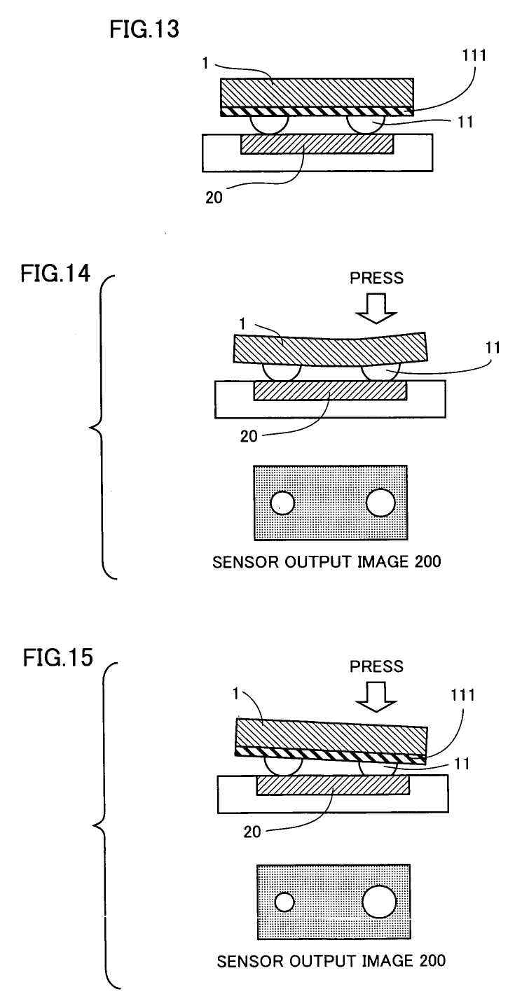

FIG. 13 shows a structure of an apparatus incorporating a pointing device according to another embodiment of the present invention.

The apparatus incorporating the pointing device is constituted by a sensor 20 obtaining image information, a cover 1 protecting a sensor surface, sensor pressers 11 arranged at a face of the cover on the sensor side so as to be in contact with the sensor surface, and a pressing direction adjustment assisting member 111 interposed between cover 1 and pressers 11.

The difference between the present structure and the aforementioned structure (such as in FIG. 6) is the presence of pressing direction adjustment assisting member 111 that is interposed between the cover and the pressers.

With the aforementioned structure, depending on the materials of cover and presser (for example, when these components are soft), irrespective of the position of the user's finger pressing the upper portion of cover, sometimes each presser 11 substantially uniformly presses sensor 20.

FIG. 14 shows the structure of the apparatus when the materials of cover 1 and presser 11 are soft and when pressing direction adjustment assisting member 111 is not interposed, as well as an output image of sensor 20.

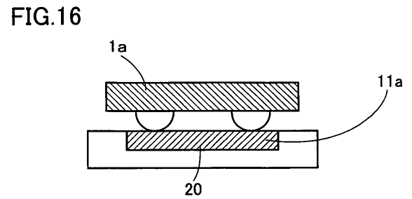

FIG. 15 shows the structure of the apparatus when pressing direction adjustment assisting member 111 is interposed between cover 1 and presser 11, as well as an output image of sensor 20.

As shown in FIG. 14, when the materials of cover 1 and presser 11 are soft and when pressing direction adjustment assisting member 111 is not interposed, the pressure is applied substantially uniformly over the entire cover. Thus, similarly, the pressure transmitted on the sensor via sensor pressers 11 become substantially uniform, and the areas pressed by the pressers 11 become uniform also in the sensor output image.

On the other hand, as shown in FIG. 15, when the pressing direction adjustment assisting member is interposed between the cover and the pressers, the pressure is applied on the cover with directivity. Thus, the pressure transmitted on the sensor via the sensor pressers likewise has directivity. On the sensor output image also, the areas pressed by the pressers have the areas reflecting the position being pressed and the strength.

Pressing direction adjustment assisting member 111 may be formed with any material as long as it has a hardness capable of assisting adjustment of pressing direction (generally, a material harder than cover 1). The pressers may be formed with any material as long as it does not damage the sensor surface.

Modification

FIG. 16 shows a modification of the pointing device shown in FIG. 14.

The pointing device is constituted by a sensor 20 obtaining image information, a cover 1a that is formed by a material having a hardness capable of assisting adjustment of pressing direction and that protects a sensor surface, and a sensor presser 11a that is arranged at a face of the cover on the sensor side so as to be in contact with the sensor surface and that is formed by a material that does not damage the sensor surface.

The difference between the present structure and the aforementioned structure is that the materials that have the hardness capable of assisting adjustment of the pressing direction and that do not damage the sensor surface are employed as the materials of the cover and the presser.

With this structure also, as shown in FIG. 15, as pressure is applied on the cover with directivity, the pressure transmitted on the sensor via the sensor pressers similarly has directivity. On the sensor output image also, the areas pressed by the pressers have the areas reflecting the position being pressed and the strength.

Cover 1a in the present modification may be formed with any material as long as it has a hardness capable of assisting adjustment of pressing direction (generally, a material harder than cover 1 of FIG. 14). The pressers may be formed with any material as long as it does not damage the sensor surface.

### Effects Of Another Embodiment

In the present embodiment, a pressing direction adjustment assisting member is interposed between a cover and sensor pressers. With this structure, the pressure resulted from pressing is applied on the cover with directivity, and the pressure transmitted on the sensor via the sensor pressers likewise has directivity. Thus, the areas pressed by the pressers have the areas reflecting the position being pressed and the strength, whereby the movement of an operator's finger can be detected more correctly.

In the modification, the cover is formed by a pressing direction adjustment assisting member and the pressers are formed by a material that is softer than the pressing direction adjustment assisting member that does not damage the sensor surface. With this structure, the pressure resulted from pressing is applied on the cover with directivity, and the pressure transmitted on the sensor via the sensor pressers likewise has directivity. Thus, the areas pressed by the pressers have the areas reflecting the position being pressed and the strength, whereby the movement of an operator's finger can be detected more correctly.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A sensor protective cover, comprising:
a cover protecting a surface of a sensor; and
a protrusion provided at a face in contact with the surface of said sensor, for causing said sensor to recognize pointing.

2. A pointing device, comprising:
a sensor obtaining image information;
a cover protecting a surface of said sensor;
a sensor presser arranged at a face of said cover on the sensor side so as to be in contact with the surface of said sensor;
an image processor detecting a change in pressure applied on said cover based on an image obtained by said sensor;
a movement detector detecting movement of an operator's finger based on said detected change in the pressure; and
a converter converting said detected movement of the operator's finger into an input value to a computer.

3. The pointing device according to claim 2, wherein
a contacting area of said sensor presser and the surface of said sensor changes by the pressure applied on said cover.

4. The pointing device according to claim 2, wherein
said sensor presser has a shape of a hemisphere or a shape of a portion cut out from a sphere.

5. The pointing device according to claim 2, wherein.
a plurality of sensor pressers are arranged at the face of said cover on the sensor side, and
said plurality of sensor pressers are respectively in contact with a plurality of portions of the surface of said sensor.

6. The pointing device according to claim 5, wherein
said plurality of sensor pressers are arranged as four sensor pressers, and
each of said plurality of portions of the surface of said sensor is a quartered portion.

7. The pointing device according to claim 2, wherein
a face of said sensor is arranged to be in a diamond shape seen from an operator, and
pressures applied near four vertexes of said diamond shape correspond to detection of movement of an operator's finger in respective up, down, left and right directions in an operation screen.

8. The pointing device according to claim 2, wherein
an image information reading scheme of said sensor is a capacitance type, an optical type or a pressure-sensitive type.

9. The pointing device according to claim 2, wherein
a material of said sensor presser is resin.

10. The pointing device according to claim 2, wherein
a material of said sensor presser is conductive resin.

11. The pointing device according to claim 2, wherein
said sensor is capable of obtaining a fingerprint or image information associated with a fingerprint as image information.

12. The pointing device according to claim 2, wherein
said cover can be removed when authentication of a user is performed, and
said cover can be attached when a pointing function is used.

13. The pointing device according to claim 12, wherein
said sensor or a body and said cover are partially connected in order to prevent said cover from completely falling off when said cover is removed for performing authentication.

14. The sensor protective cover according to claim 1, wherein
a pressing direction adjustment assisting member is arranged between said cover and said protrusion.

15. The sensor protective cover according to claim 1, wherein
said cover is formed by a pressing direction adjustment assisting member, and said protrusion is constituted by a material softer than said pressing direction adjustment assisting member that avoids a damage to the surface of said sensor.

16. The pointing device according to claim 2, wherein
a pressing direction adjustment assisting member is arranged between said cover and said sensor presser.

17. The pointing device according to claim 2, wherein
said cover is formed by a pressing direction adjustment assisting member, and
said sensor presser is constituted by a material softer than said pressing direction adjustment assisting member that avoids a damage to the surface of said sensor.
